(19) United States
(12) Patent Application Publication
(10) Pub. No.: US 2012/0120223 A1
(43) Pub. Date: May 17, 2012

(54) PORTABLE MICROSCOPE

(75) Inventors: Reto Zuest, Widnau (CH); Harald Schnitzler, Luechingen (CH); Ruedi Rottermann, Berneck (CH); Robert Lettow, Winterthur (CH)

(73) Assignee: LEICA MICROSYSTEMS (SCHWEIZ) AG, Heerbrugg (CH)

(21) Appl. No.: 13/293,289

(22) Filed: Nov. 10, 2011

(30) Foreign Application Priority Data
Nov. 15, 2010 (DE) 10 2010 043 919.3

(51) Int. Cl. H04N 7/18; G02B 21/00

(52) U.S. Cl. 348/79; 359/368; 348/E07.085

(57) ABSTRACT

A portable microscope includes an integrated operator control unit configured for at least one of selecting and adjusting at least one electrically controllable function of the microscope. The operator control unit includes at least one sensor configured to receive user control commands for at least one of activation, deactivation and adjustment of the at least one electrically controllable function. The at least one sensor includes a touch sensor and is disposed so as to accommodate holding and operation of the microscope with a single hand of a user.

### CROSS REFERENCE TO RELATED APPLICATIONS

This application claims priority to German Patent Application No. 10 2010 043 919.3, filed Nov. 15, 2010, which is hereby incorporated by reference herein in its entirety.

### FIELD

The present invention relates to a portable microscope.

### BACKGROUND

Portable or mobile microscopes are increasingly used in practice. For example, when examining samples which cannot be transported it is advantageous to bring the microscope to the sample. Such microscopes can also be used where quality control has to be performed at different locations. The term “portable microscope” as used in this specification thus especially includes a microscope which can be held in one or two hands and at the same time be operated by a user.

Microscopes are provided with a number of microscope functions. Examples of such functions include focusing functions, distance determination functions, illumination functions, profiling functions and documentation functions. In addition, many applications require capturing digital images of samples or objects being examined. Such digital image capture requires a trigger mechanism.

There are various trigger mechanisms for stationary microscopes, which are integrated into the microscope, for example, in the form of a button or switch. All of these designs are adapted to be actuated by pressure. That is, in order to capture an image, a user must exert pressure to operate the trigger mechanism. In the case of standing microscopes, the image quality is unlikely to be degraded by the operation of such buttons or switches because such microscopes are disposed or mounted in a stable manner, for example, on a laboratory bench.

In the case of portable microscopes, such triggers are mostly mounted directly on the device, in particular in the form of a switch or button, such as is described, for example, in WO 2006/124800. According to that reference, a mobile scanning head is caused to capture an image in response to actuation of a push button.

These designs have the disadvantage that pressing the trigger button or switch causes the hand-held microscope to move, thereby producing vibrations or shaking, which have a negative effect on the image quality.

Therefore, in other designs, the trigger mechanism is mounted externally, for example, in the form of a pedal or as part of an attached computer. Such externally mounted trigger mechanisms are connected to the microscope via a connecting line. By these measures, vibrations and shaking caused by pressing a trigger mechanism on the microscope are avoided, making it possible to achieve higher image quality. However, this design is disadvantages for mobile use because it does not permit single-handed operation of the instrument and therefore greatly limits the user's freedom of movement. Operator control units which are wirelessly connected to a microscope do not remedy this problem either because the user needs both hands to operate the microscope and the operator control unit, which makes it impossible to simultaneously manipulate the object to be observed.

### SUMMARY

In an embodiment, the present invention provides a portable microscope including an integrated operator control unit configured for at least one of selecting and adjusting at least one electrically controllable function of the microscope. The operator control unit includes at least one sensor configured to receive user control commands for at least one of activation, deactivation and adjustment of the at least one electrically controllable function. The at least one sensor includes a touch sensor and is disposed so as to accommodate holding and operation of the microscope with a single hand of a user.

### BRIEF DESCRIPTION OF THE DRAWINGS

Exemplary embodiments of the present invention will be described in more detail below with reference to the accompanying drawings, in which:

FIG. 1 is a simplified schematic view of an embodiment of a portable microscope, shown in a hand-held position in which a touch sensor of an operator control unit is not actuated;

FIG. 2 is a view similar to that of FIG. 1, but showing a hand position in which the touch sensor of an operator control unit is actuated;

FIG. 3 is a view similar to that of FIG. 1, but showing another hand position in which the touch sensor of an operator control unit is actuated or actuatable;

FIG. 4 is a simplified schematic plan view of a touch sensor which is partitioned into different sections; and

FIG. 5 is a cross-sectional side view of a particularly embodiment of a touch sensor which is designed as a capacitive sensor.

### DETAILED DESCRIPTION

In an embodiment, the present invention provides a microscope which overcomes the aforementioned disadvantages and is therefore easier and more ergonomic to operate. This is especially relevant in connection with mobile microscopes, which should preferably be independent of an external control unit, and which are also intended, in particular, to allow images to be captured in an ergonomic manner without operating an external unit and without shaking.

The use of a touch sensor on a portable microscope, as proposed by an embodiment of the present invention, completely eliminates the need to use separate operator control units for selecting and/or adjusting electrically controllable microscope functions, thereby making it possible to achieve a significantly simplified microscope configuration.

Advantageously, the microscope can be connected to a control unit, which may be in the form of a computer. This control unit may also be at least partially integrated into the microscope.

The use of a touch sensor completely eliminates the need for moving parts, such as switches or control buttons. Because of this, a microscope according to an embodiment of the present invention requires less maintenance than conventional microscopes. In addition, such a sensor is easy to clean. Moreover, such a sensor can be provided with a protective film which can be easily removed and replaced to allow for hygienic operation.

It is also possible for such a microscope to be entirely packed in a protective covering, allowing it to be used in a sterile environment.

The use of a touch sensor is advantageous in particular also during image capture because, in contrast to conventional pressure-sensitive sensor elements, a touch sensor makes it possible to avoid vibrations and shaking.

A portable microscope configured in accordance with an embodiment of the present invention can be held in and controlled in one hand (by the same hand). All functions of a microscope, such as holding, aligning, zooming, focusing, triggering image capture, can be activated without repositioning the hand.

The term “touch sensor” as used in this application is understood to include all types of sensors or actuating devices that avoid mechanical depression of a control element, such as a key or a button. Thus, this term includes, in particular, sensors where actuation is achieved by placing, for example, a finger immediately above the surface, or on the surface, without having to apply any pressure or while applying as low a pressure as desired. The latter option may also be referred to as “pressureless actuation”. Thus, in the context of the present invention, “touch sensor” is meant to include, for example, touch screens or touch screen sensors which allow functions of the microscope to be invoked and/or controlled simply by touch. Such touch sensors can be operated, for example, by briefly tapping on them with a finger (such as when clicking a mouse) and/or by dragging or swiping a finger (such as during a drag-and-drop operation or during continuous adjustment of a parameter). The term “touch sensor” is also meant to include sensors which are provided, for example, with a protective layer or film and where the user does not touch the actual sensor, but the protective layer provided thereon. In addition, this term is meant to include sensors which can be actuated by approaching, for example, a finger to very close distances of, for example, less than 1 mm. It is emphasized that the term “touch sensor” especially includes a pressurelessly operable sensor without display means. Thus, a preferred embodiment of the touch sensor includes no display means such as an LCD panel. Existing touch screens include a touch sensitive sensor and an LCD display. A touch sensor according to a preferred embodiment of the invention, which does not include an LCD display, can thus be provided substantially cheaper than an existing touch screen. Also, its energy consumption is substantially reduced, making it especially useful for portable microscopes, which are typically powered by rechargeable batteries. Also, size and weight of the sensor and thus the portable microscope can be minimized. The touch sensor comprises a touchless working cell, such as electrodes or capacitors, which are covered by a protective layer or a housing. The user touches that protective layer or housing. The switching function of such touch sensors is, for example, based on the change of capacity or electrical field by means of the touching finger which causes the desired effect through the protective layer or housing. As opposed to previously known actuation buttons, the sensitivity of the touch sensor is easily adjustable, for example in dependence on the thickness and material of the protective layer or housing.

In the microscope of an embodiment of the present invention, images are advantageously captured digitally. That is, observation rays originating from an object to be observed are projected by a microscope optical system onto an image sensor. Image processing may be performed in the microscope or in the control unit of the microscope. Real-time images may conveniently be displayed on a monitor associated with the control unit.

It is advantageous that the digital capture of an image being observed can be triggered by actuating the at least one sensor. “Digital capture” is understood to include both video images and still images. The use of a touch sensor allows such captures to be made in a particularly shake-free manner. A suitable image sensor is advantageously integrated into the portable microscope. The image sensor captures real-time video images and still images of the object being observed. It is also possible to use different image sensors for real-time video images and still images.

Advantageously, such a touch sensor can be operated by swiping a finger across the sensor surface. This movement does not change the position of the hand and does not subject the microscope to any vibrations. This enables particularly convenient control of image capture functions and/or continuously adjustable microscope functions, such as a zoom function.

It is preferable that the at least one sensor is arranged so that the swiping motion is a one-dimensional swiping motion. A portable or hand held microscope, which is held and operated with the same hand, can be handled safely and reliably in case the required swiping motion of a finger need only be in one direction.

Advantageously, the non-contact sensor is arranged symmetrically with respect to a handle portion of the microscope. This allows the non-contact sensor to be operated equally well by right-handers and left-handers. The handle portion may be configured cylindrically, for example. Alternatively or in addition, the handle portion may be ergonomically adapted to fit the shape of a gripping hand.

The use of capacitive sensors turns out to be advantageous in terms of ruggedness, reliability and inexpensive availability. Capacitive touch screen sensors and touch screens may take the form of, for example, glass substrates coated with transparent metal oxide. A voltage applied, for example, in the corner regions produces a uniform electric field, causing a minimal charge transfer which can be measured as an electric current. The electric currents produced are related to the position of contact or touch. Another variant of capacitive touch sensors or touch screens uses two planes of conductive strips which are arranged perpendicular to each other and electrically insulated from one another. One plane serves as a sensor, the other one as a driver. Placement of a finger at the intersection of two strips causes the capacitance of the so-formed capacitor to change, which results, for example, in a stronger signal being received by the receiver or sensor strip. It is also conceivable to use resistive or inductive sensors.

It turns out to be advantageous to partition the sensor into sections, each of which can be assigned at least one function of the microscope. Such sections can be adjusted, for example, in size and/or freely assigned with functions, so that the functionality of the sensor can be adapted, for example, to the size of a user's hand. This partitioning of the sensor into different sections can be achieved and/or changed via the control unit or, for example, also by actuating the sensor, for example with a swiping motion of a finger. Moreover, the assignment of sections with functions can be selected or changed analogously. Such partitioning of a sensor, such as a touch screen, into different sections makes it possible to account for a multitude of microscope functions and to completely dispense with, for example, external devices for controlling the microscope.

The sections of the sensor are advantageously separated by suitable markings. Such markings may be in mechanical or electronic form, such as in visual or audible form. Examples include mechanical edges, light lines or audible alerts. This provides increased ease of use.

Further, it is preferred that the at least one electrically controllable function include at least one continuously or infinitely adjustable function which can be adjusted, in particular, by actuating the sensor with a swiping motion. Examples of such functions include zoom functions or illumination adjustment functions, which can be controlled particularly easily with a swiping motion of a finger. In addition, it is also convenient that switchable functions, such as image capture, are activated and/or deactivated with swiping motions.

Overall, from an ergonomic point of view, it turns out to be very convenient if the entry of control commands into a portable microscope is performed by actuating a touch sensor. Substantially pressureless tapping motions and/or (also substantially pressureless) swiping motions turn out to be particularly practical for this purpose.

According to a further preferred embodiment the touch sensor is arranged on the inside surface of the handle portion of the portable microscope. A touch sensor, typically a capacitive sensor, can consist of two electrodes, between which an electrical field is generated. By simple constructional means such sensors can be arranged on the inside surface of a housing. The electrical field can penetrate the housing, and corresponding actuation positions for the sensor can be shown by markings or prints on the outside of the housing. Actuation of such a sensor arranged on the inside of the housing is thus easily achievable by (for example) swiping a finger over the outside of the housing. Such sensors, arranged on the inside of a (protective) housing, are essentially maintenance free and safe from environmental influences such as dust or dirt. The housing can be formed in a special way for example with indentations, allowing a more intuitive actuation using a finger. Be it also noted that (two-dimensional) touch screens according to the prior art require extensive areas in order to be able to display images, functions etc. As opposed hereto, the touch sensors of the present invention are localized elements, which can be provided with a small and space efficient sizing. As the individual sensors or sensor sections are small, the form of the sensor(s) can be made to conform to the surface of the microscope or the handle of the microscope. This especially holds in case of an arrangement of the sensors or sensor sections along a straight line. Thus, the microscope according to embodiments fo the invention can be provided with a slim shape easily holdable and operable in one hand. Also, for touch sensors according to this preferred embodiment, no eye contact is necessary, as the sensor is operated by moving a finger in only one direction. Individual sensor elements can be separated from another by electronic or mechanical means. It is thus not necessary to be able to see the touch sensor while operating.

Preferably, the arrangement of the sensors and/or the sections of the sensors can essentially be one-dimensional, i.e. in a straight line, so that actuation of the sensors (or sensor sections) can be performed in a simple and ergonomic way by moving (i.e. swiping) a finger along said line. This enables a simple motion to perform operation of a portable, hand held microscope, as the microscope can be held in one hand, and at the same time the sensors can be easily actuated (with the same hand). Such a simultaneous holding and actuating would be substantially more difficult if the finger actuating the sensors had to be moved in more than one direction, for example in directions perpendicular to one another. This especially holds in case of a cylindrical handle portion, for both right handed and left handed users. Such a simple actuation motion (by moving a finger in only one direction) greatly enhances stable and safe handling of a portable microscope, for example when triggering a digital image capture.

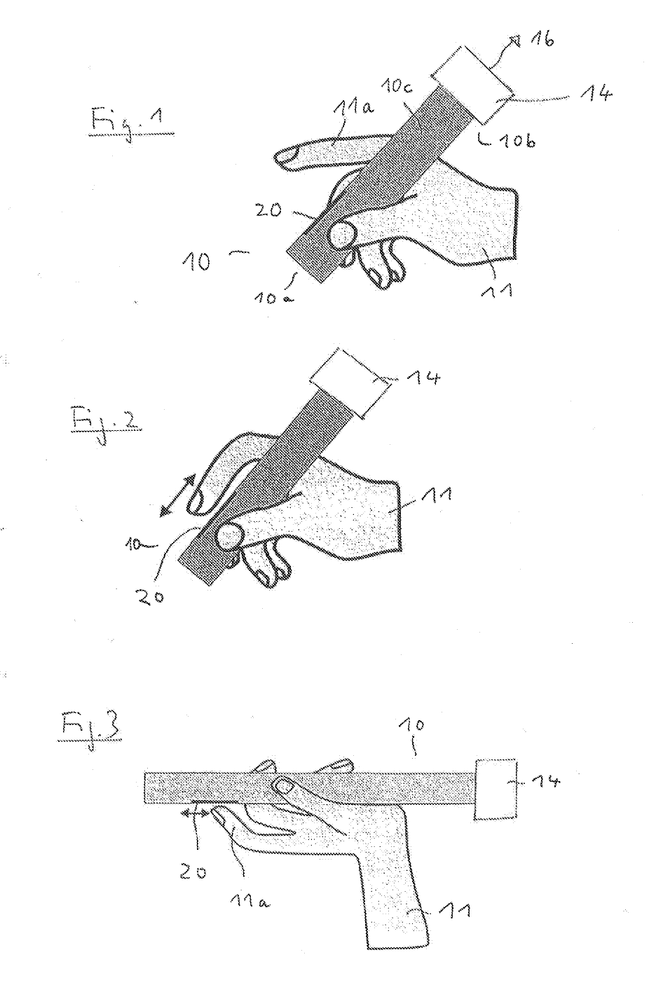

Referring to FIG. 1, an embodiment of a portable microscope according to the present invention is schematically illustrated in simplified form and generally designated 10. Microscope 10 can be carried and operated by a user with only one hand 11, as will be described in more detail hereinbelow.

Portable microscope 10 has a front end 10a, which is oriented toward the object to be observed, and a rear end 10b. The microscope has imaging optics integrated therein. An imaging device, here in the form of a CCD sensor or a digital camera 14, is provided at rear end 10b. The portable microscope is connected to a control unit, or processing and analysis unit, either wirelessly or via a wired connection 16. This processing and analysis unit is not specifically shown, but may conveniently take the form of a computer with a monitor. The control unit may also be at least partially integrated into the portable microscope.

Microscope 10 has a symmetrical housing 10c, which in this case is cylindrical in shape and which accommodates the optical components of the microscope, such as the main objective, the zoom system or additional lenses. Advantageously, the cylindrical microscope body 10c is also provided therein with an illumination device. Alternatively and/or in addition, an illumination device may also be provided on the outer surface of cylindrical microscope body 10c. These components are not specifically shown in the figures.

Cylindrical microscope housing 10c has configured thereon an operator control unit having a sensor 20 which is designed as a touch sensor and can be actuated to enter user control commands. In order to actuate sensor 20, it is not necessary for any pressure to be exerted, for example, by index finger 11a of hand 11. Sensor 20 can be actuated by placing finger 11a directly above the surface of sensor 20, as is illustrated in FIG. 2. At the same time, sensor 20 may also be actuated and/or manipulated by swiping motions of finger 11a across the sensor surface.

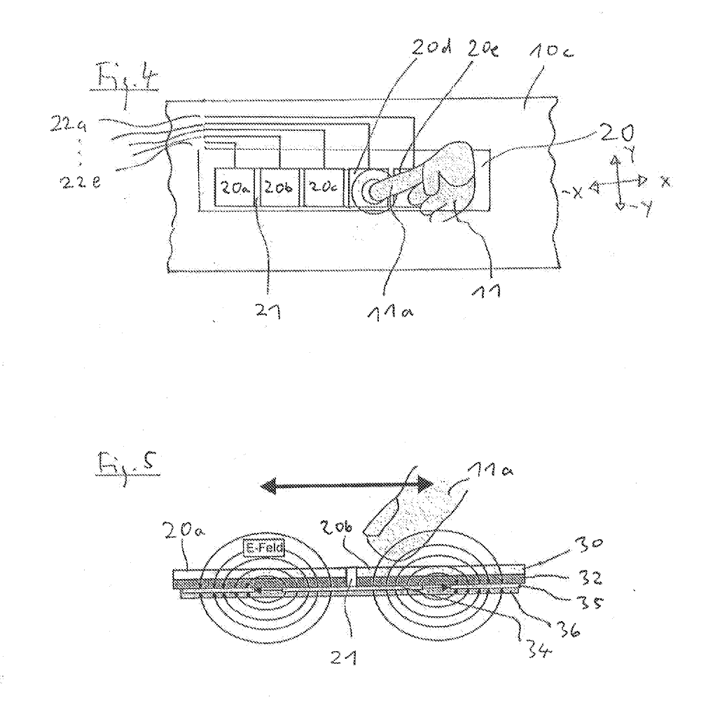

Another way of holding and actuating sensor 20 is illustrated in FIG. 3. All in all, it can be seen that the ability of sensor 20 to be actuated in a substantially pressureless manner allows it to be held and manipulated in different ways, of which only two are illustrated merely by way of example.

Referring to FIG. 4, there is shown, in plan view, the portion (handle portion) of cylindrical microscope housing 10c that has sensor 20 configured therein. It can be seen that sensor 20 has (by way of example) five sensor sections 20a through 20e, which are arranged along the axis or longitudinal extension of the cylinder (x- and −x-directions in FIG. 4). I.e, the sensor sections are arranged along one straight line. The symmetrical arrangement of the sensor sections along the longitudinal axis of the cylinder ensures that the sensor and the individual sensor sections can be operated equally well by both a right-handed and a left-handed person. To further increase the ease of use, the individual sections 20a through 20e of sensor 20 are separated from one another by light bars 21. The transition from one sensor section to an adjacent sensor section may also be indicated by audible signals.

Sensor 20 may be designed in particular as a touch sensor (without any display means) or a touch screen sensor, it being possible for the individual sensor sections 20a through 20e to vary in size or in their functional motion.

The individual sensor sections 20a through 20e are connected via channels 22a through 22e to components respectively associated therewith. For example, a sensor section that is suitable for the hand size of a user, or also several sensor sections, may be connected to digital camera 14. Digital camera 14 is operated in response to suitable (pressureless) actuation of the associated sensor section or sections. Other sensor sections may be assigned additional functionalities of the microscope. For example, at least one sensor section may be assigned to control the zoom, another sensor section may be assigned to control the illumination, etc. It is to be understood that these functionalities are mentioned merely by way of example.

In a particularly simple basic version of function assignment to sensor sections 20a through 20e, all sensor sections 20a through 20e are assigned to digital camera 14 in such a way that a swiping motion of finger 11a across any desired sensor section will produce a digital image (live image). For example, it is possible to cause digital camera 14 to be triggered by one swiping motion or each swiping motion in a specific or first direction (e.g., the x-direction in FIG. 4). However, if it is desired, for example, to also change the magnification of the microscope by actuating the zoom system, this trigger function can be canceled by a swiping motion in the opposite or second direction (e.g., the −x- or the y- or −y-direction in FIG. 4). In that case, for example, the zoom function may be assigned to one or more sections of the sensor. If it is desired to reactivate the trigger function, it is possible to do so, for example, by one or more (e.g., two) further swiping motions in the first direction. It turns out to be advantageous, in particular, to provide at least one sensor section in which continuous microscope functions and adjustments can be changed by swiping motions. Examples of this include the above-discussed zoom function, the illumination intensity, and also the focusing of the microscope.

The assignment of functions to the respective sensor sections can be done via the higher-level control unit (computer), which may display or overlay, for example on a monitor, a function library from which the user may select and allocate the required or desired functions to the sensor sections.

Also, the user can assign different setpoints to the individual sensor sections 20a through 20e, for example, in order to define a control range, for example, for the magnification or the illumination intensity. Individual assignment of functions to the sensor or sensor sections by a user makes it possible to minimize or substantially eliminate user errors. It is also possible, for example, to assign each two sensor sections two respective limits of an adjustment range (such as a zoom range), in which case it is possible, for example, to increase the zoom factor by a swiping motion in the x-direction in FIG. 4, and to decrease the zoom factor by a swiping motion in the −x-direction, but only between the two limits defined.

Referring to FIG. 5, there is shown an embodiment of a touch sensor or a pressurelessly actuatable sensor.

A sensor 20 in the form of a capacitive sensor or switch is shown in FIG. 5 in a side profile view. There can be seen (by way of example) two sensor sections 20a, 20b which are separated from one another by a light bar 21. For the sake of simplicity, this figure does not show any additional sensor sections. The individual sensor sections include the following layers or regions, starting from the surface: a cover layer 30, a substrate layer 32, sensing regions 34, ground potential regions 35, and an insulating layer 36.

By approaching or swiping finger 11a, the capacitance between sensing regions 34 and ground potential regions 35 is caused to change, which affects the oscillation amplitude of an RC oscillator. This causes a trigger stage downstream of the RC oscillator to flip, thereby causing the output signal of a switching amplifier to change. The operation of such a capacitive sensor is well-known in the art, and therefore does not need to be discussed further. It is also possible to conceive of other or modified embodiments, such as were mentioned in the introductory part of the description.

For the sake of completeness, it should be noted that the pressureless actuation of sensors according to embodiments of the present invention may also be implemented using other types of sensors, such as optical or inductive touch sensors.

Due to the ergonomic arrangement of sensor 20 on the portable microscope, the user does not need to change the position of his or her hand while operating the device. Moreover, there is no need to look at the controls; i.e., the individual sensor sections. For optimal handling of the microscope, care should be taken to keep the actively holding fingers from actuating the sensor or sensor sections.

For example, when observing an object whose rear surface has a difficult or complex geometry, the user can hold or move the object in his or her second, free hand, and therefore can completely dispense with complex holding means for the object or specimen or even an expensive rotary stage. Furthermore, a user can easily change the direction and/or intensity of an external light source (such as a gooseneck light) with his or her free hand.

It is convenient to actuate the sensor or sensor sections using index finger 11a. This ensures optimal stability and tremble prevention for the microscope. The microscope may advantageously have a sensor for detecting a trembling motion of the hand (that does not result from user actuation of the sensor or sensor sections). Such trembling motion may be compensated for by a built-in image stabilizer. Alternatively, it would be possible to use an external logic to ensure that the microscope; i.e., image capture, is not activated until the degree of trembling falls below a predetermined threshold.

Audible or visual signals may indicate to the user when the device is ready to capture images. For this purpose, LEDs, e.g., green LEDs, can be used to indicate that image capture is possible, whereas red LEDs, for example, are used to inform the user of excessive trembling motion. However, by using a touch sensor according to the present invention, it is possible to minimize or substantially avoid rocking of the microscope in response to the triggering of a camera.

In another embodiment, it would also be possible to capture an image sequence or a video by changing the assignment of functions to the sensor sections accordingly. For example, video capture could be started by actuating a first sensor section and terminated by actuating a second sensor section.

The following is a summary of the above-mentioned and further functions which may be assigned to a sensor of a portable microscope according to the present invention:

The assignment of functions to the individual sensor sections may be done using, for example, the function library mentioned above.
image capture; i.e., single image and/or image sequence and/or video;
image sequence for different focus positions. This so-called Z-image stack is used, for example, for 3D reconstruction of the object;
image sequence for different zoom settings (e.g.; first image with the zoom set to 0, second image with the zoom set to 10×, third image with the zoom set to 20×, etc.);
zoom adjustment: here, it possible to define via the swiping direction whether the user will select a higher or a lower zoom factor;
illumination adjustment: the swiping direction defines whether the illumination intensity will increase or decrease;
both in the case of zooming and illumination, the swiping motion can produce a continuous change of the parameters, whereas a tapping motion is used produce an incremental (discrete) change of the parameters;
adjustment of different light sources: the white light of an LED can be produced, for example, by additive color mixing. By turning off individual color components, the sample can be illuminated with colored light. Alternatively, a small filter wheel placed before the light source could define spectral ranges for the illumination. Using the sensor, the user can select the different colors;
initialization of a focusing aid, such as two intersecting laser beams: a single dot can only be seen at the focus position, whereas outside, two dots will be seen;
activation of an autofocus function which allows the mobile microscope to automatically adjust the focus position, for example, using the autocorrelation method;
tremble sensor activation: by detecting the trembling motion of the user, it is possible to indicate favorable moments for image capture by audible or visual signals;
image stabilizer activation: as in the case of the stabilizers used in digital cameras, such a stabilization mechanism may further simplify image capture;
contrast optimization activation: different surfaces and geometries require specific illumination techniques and/or directions to resolve details. For example, perpendicular illumination is preferred for steep edges (e.g. boreholes). Contrast optimization performs edge detection; i.e., image analysis, on the image of an object and attempts to optimize it by varying the illumination;
activate audio capture: for documentation purposes, it may be advantageous for the user to add a comment to an image/image sequence/video and to store it along with the image or image sequence or video. This allows the user to create extensive documentation without having to put the microscope aside and remove his or her hand from it.

As described earlier, it is advantageous to control microscope functions using a sensor having at least two sensor segments or sections, and to do so by making a swiping motion in the longitudinal and/or transverse direction of the sensor. Activation and deactivation are accomplished via the time sequence in which the sensor sections are actuated during the swiping motion.

There are specific control modes for the at least one sensor. These control modes can also be combined with each other. The selection is preferably made via an external control unit. The different control modes are advantageously integrated in a function library of the control unit.

A first mode is used, for example, to activate and deactivate specific functions (e.g. image capture). In this mode, it is possible to define activation points. Depending on the user's requirements (e.g., hand size), these activation points may be located, for example, at the start and end point of the sensor, but also in any other region or section. A longitudinal swiping motion from the start point to the end point invokes and/or controls a particular function. The start and end points may also be activated by a transverse swiping motion. Alternatively, it is possible to assign a motion direction to an activation or deactivation operation. It is also conceivable to control several functions such that, for example, a first sensor section activates image capture, a second section activates audio capture, a third section stops audio capture, and a fourth section stops image capture.

A second mode may be used, for example, for continuous adjustment of specific parameters (e.g., zoom adjustment or illumination). It is possible, for example, to assign a parameter value to each of the start and end points of the sensor, and to define the manner in which the parameter is to change between these two points, such as for example, linearly or exponentially. For coarse adjustment, the maximum and minimum parameter values are selected as start and end points (e.g., minimum zoom setting at the start point, maximum zoom setting at the end point). For fine adjustment, the sensor may be programmed for a smaller parameter range. For example, the start point may correspond to a 10× zoom setting, and the end point may correspond to a 15× zoom setting. As a result of the assignment of parameter values, the sensor reacts in a direction-dependent manner; i.e., when the finger moves from the center of the sensor toward an end point, the respective parameter changes toward the end-point value.

While the invention has been particularly shown and described with reference to preferred embodiments thereof, it will be understood by those skilled in the art that various changes in form and details may be made therein without departing from the spirit and scope of the invention.

What is claimed is:

1. A portable microscope comprising an integrated operator control unit configured for at least one of selecting and adjusting at least one electrically controllable function of the microscope, the operator control unit including at least one sensor configured to receive user control commands for at least one of activation, deactivation and adjustment of the at least one electrically controllable function, the at least one sensor including a touch sensor and being disposed so as to accommodate holding and operation of the microscope by a single hand of a user.

2. The microscope recited in claim 1, wherein the at least one sensor is configured to trigger a capture of a digital image.

3. The microscope recited in claim 1, wherein the at least one sensor is operable with a swiping motion of a finger of the user across a surface of the at least one sensor.

4. The microscope recited in claim 1, wherein the at least one sensor is operable with a one-dimensional swiping motion of a finger of the user across a surface of the at least one sensor.

5. The microscope recited in claim 1, wherein the microscope includes a handle portion and wherein the at least one sensor is symmetrically disposed with respect to the handle portion.

6. The microscope recited in claim 1, wherein the at least one sensor includes a capacitive sensor.

7. The microscope recited in claim 1, wherein the at least one sensor includes partitioned sections, each section being assigned to at least one function of the microscope.

8. The microscope recited in claim 7, wherein the sections of the sensor are separated from one another by electronic or mechanical markings.

9. The microscope recited in claim 1, wherein the at least one electrically controllable function includes at least one continuously or infinitely adjustable function operable by actuating the at least one sensor with a swiping motion.

10. The microscope recited in claim 1, wherein the at least one sensor is assignable to different microscope functions by actuating at least one of a control unit or the sensor, and wherein an assigned microscope function is changeable.

11. The microscope recited in claim 1, wherein the microscope includes a handle portion and wherein the at least one sensor is disposed on an inside surface of the handle portion.

12. The microscope recited in claim 1, wherein the at least one sensor includes a plurality of sensors disposed along a straight line.

13. The microscope recited in claim 1, wherein the at least one sensor includes sections, and wherein the sections of the at least one sensor are disposed along a straight line.

14. A method of operating a portable microscope including at least one electrically controllable function, the method comprising:
providing an integrated operator control unit configured for at least one of selecting and adjusting at least one electrically controllable function of the microscope, the operator control unit including at least one sensor configured to receive user control commands for at least one of activation, deactivation and adjustment of the at least one electrically controllable function of the microscope, the at least one sensor including a touch sensor and being disposed so as to accommodate holding and operation of the microscope by a single hand of a user; and
entering at least one control command into the microscope by actuating the touch sensor, the at least one control command including the at least one of activation, deactivation and adjustment the at least one an electrically controllable function of the microscope.

15. The method recited in claim 14, wherein the actuating the touch sensor so as to activate the at least one control command includes at least one of a substantially pressureless tapping motion and a swiping motion.
